(19) United States
(12) Patent Application Publication
(10) Pub. No.: US 2019/0147665 A1
(43) Pub. Date: May 16, 2019

(54) GESTURE BASED 3-DIMENSIONAL OBJECT TRANSFORMATION

(71) Applicant: Hewlett-Packard Development Company, L.P., Houston, TX (US)

(72) Inventors: Madhusudan R. BANAVARA, Bangalore (IN); Sunitha KUNDER, Bangalore (IN)

(21) Appl. No.: 16/097,381

(22) PCT Filed: Jun. 15, 2017
(86) PCT No.: PCT/US17/37752

§ 371 Date: Oct. 29, 2018

(30) Foreign Application Priority Data
Jul. 16, 2016 (IN) IN201641024427

(51) Int. Cl. G06T 19/20; G06F 3/01

(52) U.S. Cl. CPC G06T 19/20; G06T 2200/04; G06F 3/017

(57) ABSTRACT

In one example, an apparatus is disclosed, which includes a display unit to display a 3D object, a set of sensors to track movement of user's hands, a gesture recognition unit to determine user's gesture based on tracked movement of the user's hands, and a gesture controller to transform a shape of the 3D object based on the users gesture. The display unit may display the transformed 3D object.

### BACKGROUND

Three-dimensional (3D) display technologies may facilitate 3D visualization of an object. Different types of 3D display technologies may include stereoscopic and true 3D displays. Some stereoscopic display apparatuses may need a user to wear specialized glasses to obtain a stereoscopic perception. Autostereoscopic display may provide a viewer with the perception of viewing the object in 3D without requiring the viewer to use an eyewear. True 3D displays may display an image in three dimensions. Examples of true 3D display technology may Include holographic displays, volumetric displays, integral Imaging arrays, and compressive light field displays.

### BRIEF DESCRIPTION OF THE DRAWINGS

Examples are described in the following detailed description and in reference to the drawings, in which:

FIG. 1 is a block diagram of an example apparatus to transform a shape of a 3D object based on user's gesture;

FIG. 2 is a block diagram of the example apparatus illustrating additional components to transform the shape of the 3D object;

FIGS. 3A and 3B illustrate an example scenario depicting cameras that are used to capture hand and fingers with a known/blank background to transform a 3D object;

FIG. 3C illustrates an example display depicting the user's hand and fingers superimposed over the 3D object;

FIG. 4A is an example scenario illustrating a tool as seen by a camera;

FIG. 4B is an example display depicting the tool superimposed over the 3D object as seen by a user;

FIG. 5 is an example flow chart of a method to transform a shape of a 3D object based on user's gesture; and

FIG. 6 illustrates a block diagram of an example computing device to transform a shape of a 3D object based on user's gesture.

### DETAILED DESCRIPTION

Three dimensional (3D) display techniques have been well developed today. Example 3D display may include stereoscopic display, autostereoscopic display, or true 3D display. Further, 3D controlling and interaction may have become ubiquitous in modern life. Industrial modeling solutions, such as Autodesk and computer-aided design (CAD), may be used to create/edit 3D models (e.g., 3D objects). In such cases, a user may need to understand bow the 3D model is represented, non-intuitive mouse and keyboard based inputs for making changes to the 3D model, and/or programming interfaces associated with the 3D representations.

Examples described herein may provide a mechanism to create, modify and save 3D objects using multiple cameras interpreting natural gestures and tools. A computing device with multiple sensors (e.g., cameras) may track movement of user's hands, fingers, fools or a combination thereof. A gesture recognition unit may determine user's gesture based on tracked movement of the user's hands, fingers, tools or a combination thereof. A gesture controller may transform a shape of the 3D object based on the user's gesture. The transformed 3D object may be displayed in a display unit (e.g., 3D capable television or a holographic display unit). Example 3D object may be a virtual object.

In one example, the 3D object may include a 3D stereoscopic object. In this case, the gesture recognition unit may superimpose the user's hands and the 3D object in a virtual space. Superimposing of the user's hands and the 3D object can be viewed on the display unit or can happen in background memory. Further, the gesture recognition unit may determine the user's gesture relative to the 3D object based on tracked movement of the user's hands, fingers, tools or a combination thereof upon superimposing the user's hands and the 3D object.

In another example, the 3D object may include a 3D holographic object. In this case, the gesture recognition unit may determine when the user's hands come within a predetermined range of interaction with the 3D holographic object. Further, the gesture recognition unit may determine user's gesture relative to the 3D holographic object when the user's hands come within the predetermined range of interaction with the 3D holographic object.

For example, multiple cameras may capture different perspectives of a 3D object in a 3D space and allows the user to push, prod, poke and/or squish the 3D object with hands/fingers/tools to transform a shape of the 3D object. The cameras may track the fingers/hands/tools to deduce the user's gesture. For example, consider the 3D object being a cotton ball. In this case, when the user holds the 3D object with hands and brings the hands closer, the 3D object gets squished and flattens out along the border of user's hands, which can either be displayed on a 3D display device (e.g., 3D capable television) or a holographic visualization tool.

Examples described herein may include gloves to provide a mechanism for the scanning device (e.g., cameras) to identify boundaries of 3D object and hands/fingers/tools. Examples described herein may enable to select various types of virtual base materials with different characteristics for modeling the 3D object, for example, cotton for soft and easily shrinkage material, wood for hard material, latex for flexible material, clay for malleable materials, or a combination thereof. Examples described herein may provide a potter's wheel like functionality which may provide easy mechanisms to add elements with circular symmetry. In some examples, the gloves may be capable of providing tactile feedback for the selected virtual base material to enhance user experience.

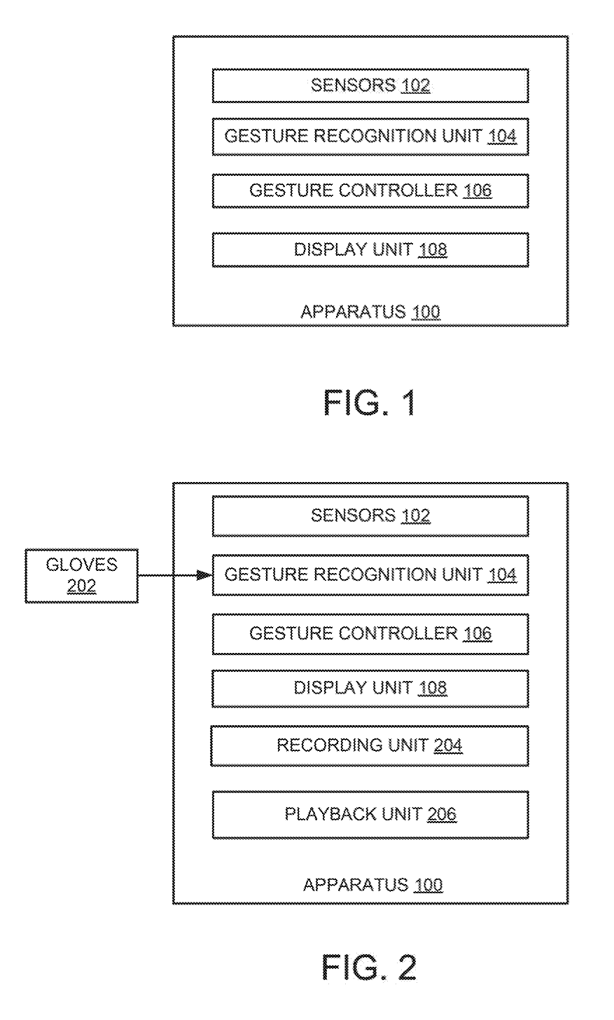

Turning now to the figures, FIG. 1 is a block diagram of an example apparatus 100 to transform a shape of a 3D object based on user's gesture. Example apparatus 100 may include a computing device. Example computing device may include a user/client computer, server computer, smart phones, notebook computers, pocket computers, multi-touch devices, and/or any other devices with processing, communication, and input/output capability. Example apparatus 100 may optionally include an external communication device such as a modem, satellite link, Ethernet card, or other device for accepting input from, and providing output to, other computers.

Apparatus 100 may include sensors 102, a gesture recognition unit 104, a gesture controller 108, and a display unit 108. Sensors 102, gesture recognition unit 104, and gesture controller 106 may be communicatively coupled/interaetive with each other to perform functionalities described herein.

During operation, display unit 108 may display/project a 3D object. Example display unit may include 3D display device such as a stereoscopic display device, autostereoscopic display device, or a holographic display device. Example 3D display device is a device capable of conveying depth perception to the viewer by means of stereopsis for binocular vision (e.g., specialized glasses). Example autostereoscopic display device may allow a viewer to experience a sensation that 3D objects are floating in front of the viewer without the use of any visual aids. Example holographic display device may utilize light diffraction to create a virtual 3D image of the 3D object and do not require the aid of any special glasses or external equipment for a viewer to see the 3D image. In another example, display unit 108 may include multi-touch device having a touch sensing surface. Example 3D object may include a 3D stereoscopic object or a 3D holographic object.

Further, sensors 102 may track movement of user's hands. Example sensors 102 may include cameras such as structured light camera, a time-of-flight camera, a stereo depth camera, a 2D camera, and a 3D camera. In one example, the cameras may track the fingers/hands/tools to deduce the operation desired. Furthermore, gesture recognition unit 104 may determine user's gesture based on tracked movement of the user's hands. Example user's gesture may include pushing, prodding, poking, squishing, twisting or a combination thereof.

In one example, user's gesture may be determined based on the tracked movement of the user's right and left hands within a 3-dimensional gesture coordinate system. In the 3-dimensional gesture coordinate system, the user's gesture may be determined based on X, Y and Z axes for determining the intended movement of the user's hands. For example, an intended right or left movement may be determined based on an average x-component of the right and left hands, an intended forward or backward movement may be determined based on an average z-component of the right and left hands, and an intended upwards or downward movement may be determined based on an average y-component of the right and left hands. Even though the examples described in FIG. 1 may determine user's gesture based on the movement of hands, the user's gestures may also be determined based on movements of fingers, physical tools, virtual tools, or a combination thereof including the hands.

Gesture controller 108 may transform a shape of the 3D object based on the user's gesture. Display unit 108 may display the transformed 3D object. In one example, when the 3D object is a 3D stereoscopic object, gesture recognition unit 104 may superimpose the user's hands and the 3D stereoscopic object in a virtual space. Superimposing of the user's hands over the 3D object may be viewed on display unit 108 or may happen in background. Further, gesture recognition unit 104 may determine the user's gesture relative to the 3D stereoscopic object based on tracked movement of the user's hands upon superimposing the user's hands over the 3D stereoscopic object.

In another example, when the 3D object is a 3D holographic object, gesture recognition unit 104 may determine when the user's hands come within a predetermined range of interaction with the 3D holographic object and determine the user's gesture relative to the 3D holographic object when the user's hands come within the predetermined range of interaction with the 3D holographic object. Alternately, cameras 102 may capture user's hands and gesture recognition unit 104 may superimpose the user's hands over the 3D holographic object in a virtual space and determine the user's gesture relative to the 3D stereoscopic object based on tracked movement of the user's hands upon superimposing the user's hands over the 3D holographic object.

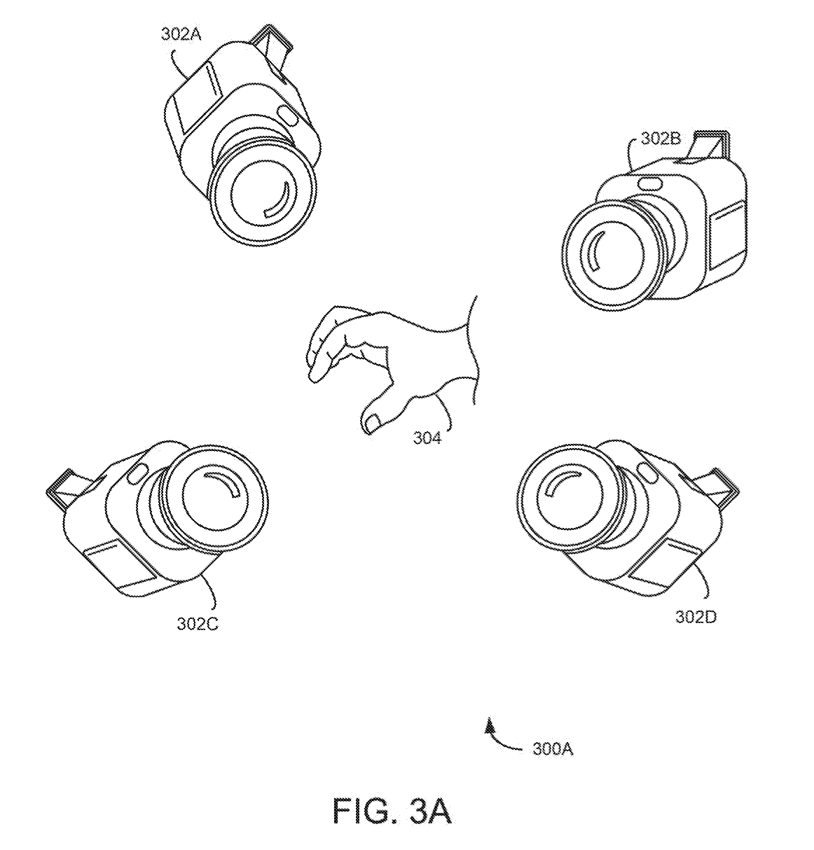

FIG. 2 is a block diagram of example apparatus 100 illustrating additional components to transform the shape of the 3D object. A user may select a set of virtual base materials and tools to start 3D Interaction with the 3D object. Different types of virtual base materials with different characteristics may be used for a modeling session. For example, the 3D object may be made of a virtual base material selected from a group consisting of cotton for soft and shrinkable material, wood for hard material, latex for flexible material, clay for malleable material or a combination thereof.

In such scenario, user may wear a special apparatus such as a glove 202 to provide a tactile feedback specific to the base material of the 3D object. The user may sense that he/she is moving his/her hands through the virtual base material and then transform the shape of the 3D object depending upon the type of selected material. Glove 202 may enable gesture recognition unit 104 to identify boundaries of the 3D object and the user's bands, such as right hand, left hand and/or fingers.

For example, gestures may represent natural hand/tool based operations to allow the user to push, prod, poke and squish the 3D object with hands/fingers, thereby editing the 3D object. Multiple cameras 102, optionally assisted by gesture gloves 202, may track natural gestures in three dimensions to provide inputs for the 3D modeling system. In this case, gesture gloves 202 may be human input devices that track gestures using accelerometers and pressure sensors, convert these gestures as inputs for a 3D editing system.

Gesture recognition unit 104 may track different parts of hands/gloves/tools of the user to deduce natural human gestures. Gesture recognition unit 104 may decipher fingers and palms as separate but connected input units to allow flexibility of different joints that are helping to shape the 3D object more intuitively. For example, when the user's hands hold edges and moves the 3D object In a circular motion, the 3D object is simply rotated in a direction of the circular motion. If a distance between hands/fingers reduces, the 3D object between the hands/fingers may get squeezed at points where the hands/fingers make contact with the 3D object. Further, compression of the 3D object may depend on a type of the virtual base material. For example, if the virtual base material is cotton, the compression/squeezing may happen immediately. If the virtual base material is wood or steel, the compression/squeezing gesture may not change the shape/size of the 3D object. If the virtual base material is rubber, the squeeze is undone when the fingers go back to their original position.

Further, apparatus 100 may include a recording unit 204 to record an iteration of the movement of the user's hands, physical tools, virtual tools, or a combination thereof during the transformation of the 3D object. Apparatus 100 may further include a playback unit 206 to repeat the iteration multiple times to transform the shape of the 3D object based on user-defined rules. Example user-defined rules may include a number of times the iteration is to be repeated, a time duration for the iterations and the like. For example, a macro recording functionality can be implemented to record one iteration of movement of hands/fingers/tools and a macro playback may be implemented to repeat the iteration multiple times (e.g., one saw like motion performed and recorded by the user can be repeated to create a set of teeth resembling a hack-saw blade).

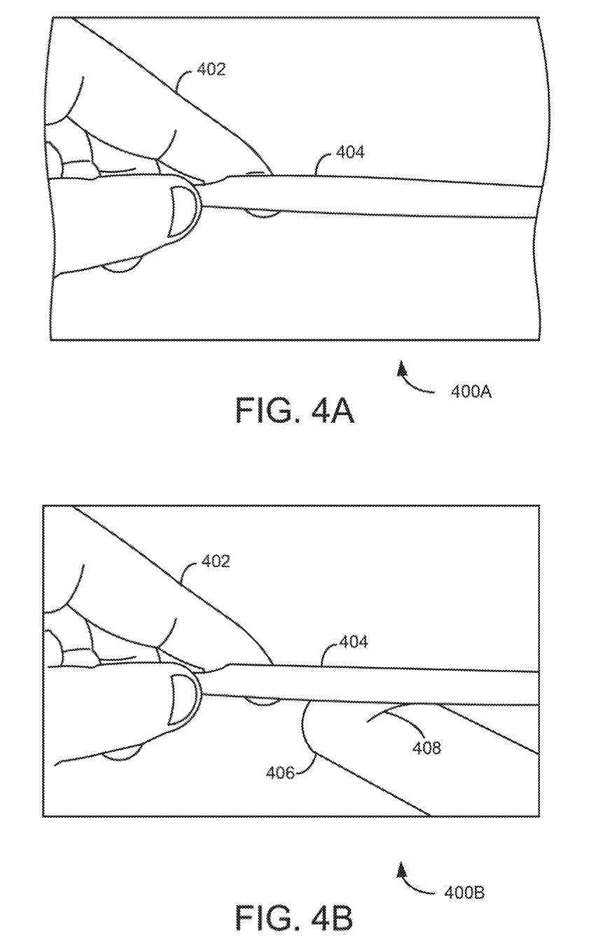

The hands/fingers tracked by cameras/sensors 102 and gesture recognition unit 104 can also be augmented by physical tools such as a filing tool, a pin, a saw and the like, Further, gesture recognition unit 104 may allow creation of virtual tools such as a file, knife, needles, and the like for the hand/glove to use in shaping the 3D object. In yet another example, gesture controller 106 may enable shaping of the 3D object using physical tools, virtual tools, or a combination thereof. Example virtual tools may be selected from a graphical user interface of display unit 108. This is explained in FIG. 4.

In another example, the 3D object may be programmed to move in a spatial pattern (e.g., rotation). The shape of the 3D object can be transformed using a potter's wheel like functionality. When the 3D object is rotating, the potter's wheel functionally may provide easy mechanisms to add elements with circular symmetry. During horizontal and vertical linear motion of the 3D object, the 3D object may move up and down, and back and forth to possibly create a zig zag saw like pattern.

In one example, the components of apparatus 100 may be implemented in hardware, machine-readable instructions or a combination thereof. In one example, each of gesture recognition unit 104, gesture controller 106. recording unit 204, and playback unit 206 may be implemented as engines or modules comprising any combination of hardware and programming to implement the functionalities described herein. Even though FIG. 1 describes about apparatus 100, the functionality of the components of apparatus 100 may be implemented in other electronic devices such as personal computers (PCs), server computers, tablet computers, mobile devices and the like. Further, sensors/cameras 102 can be connected to apparatus 100 via wired or wireless network.

Apparatus 100 may include computer-readable storage medium comprising (e.g., encoded with) instructions executable by a processor to implement functionalities described herein in relation to FIGS. 1-2. In some examples, the functionalities described herein, in relation to instructions to implement functions of gesture recognition unit 104, gesture controller 108, recording unit 204, and playback unit 206 and any additional instructions described herein in relation to the storage medium, may be implemented as engines or modules comprising any combination of hardware and programming to implement the functionalities of the modules or engines described herein. The functions of gesture recognition unit 104, gesture controller 106, recording unit 204, and playback unit 208 may also be implemented by the processor. In examples described herein, the processor may include, for example, one processor or multiple processors Included in a single device or distributed across multiple devices.

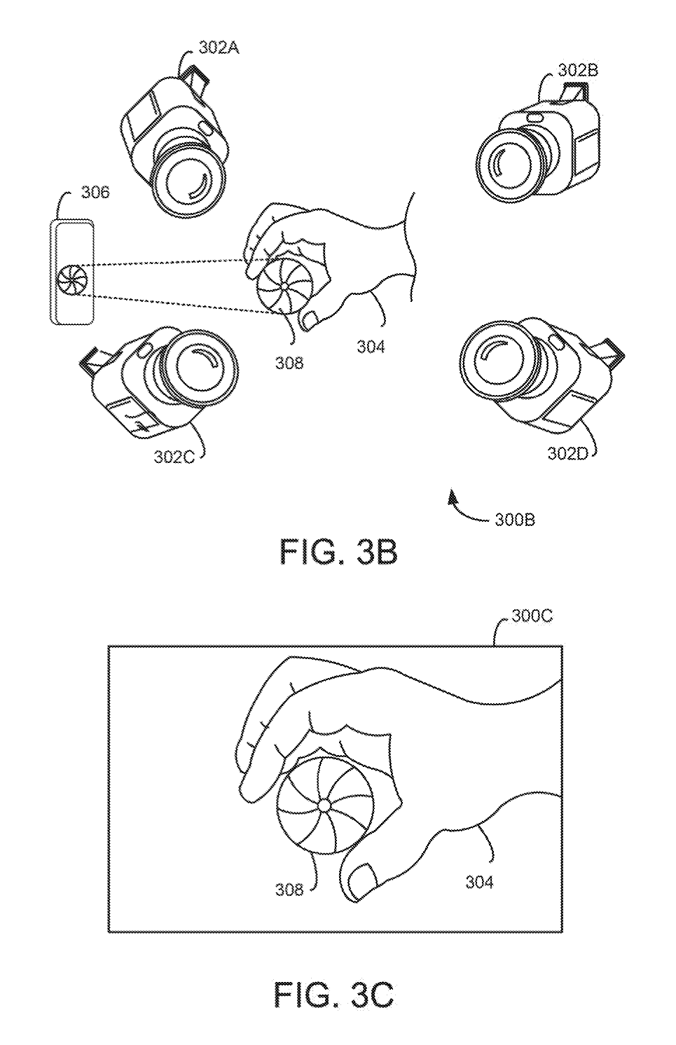

FIGS. 3A and 38 illustrate an example scenario depicting cameras 302A-D that are used to capture hand and fingers (e.g., 304) with a known/blank background to transform a 3D object/virtual object 308. Particularly, FIG. 3A illustrates an example scenario 300A depicting cameras that are used to capture hand and fingers 304, for instance, for manipulating a 3D stereoscopic object. FIG. 3B illustrates an example scenario 30GB depicting cameras 302A-D that are used to capture hand and fingers 304, for instance, for manipulating a 3D holographic object 308. Example 3D holographic object may be projected from a computing device 306, which may be used to determine user's gestures and then manipulate the 3D objects.

Multiple cameras 302A-D (e.g., 3D and/or 2D cameras) may capture hands and fingers (e.g., 304) with a known/blank background. For example, cameras 302A-D may he placed 180 degrees around user's hands and fingers 304. Cameras 302A-D may capture fingers, palm and real tools and the users may see the 3D object being modified and fingers, palm, virtual tools and real tools on 3D television. Conceptually the 3D object being edited is fixed in space or can be tilted, rotated and moved by the bands/tools that manipulate the 3D object.

Gesture recognition unit (e.g., 104) may recognize contours of the hand/fingers 304 from cameras 302A-D, use the known/blank background as a reference, superimposes 3D object 308 in virtual space (e.g., may allow viewing of such a superimposed object and hand/fingers 304 from different camera angles), recognize the movement of hand/fingers 304 as effort to manipulate 3D object 308 between hands/fingers 304 and affects the manipulation/transformation of 3D object 308. FIG. 3C illustrates an example display unit 300C (e.g., 3D display unit) depicting the user's hand and fingers 304 superimposed over 3D object 308 as seen by the viewers.

FIG. 4A is an example scenario 400A illustrating a tool 404 as seen by a camera. Cameras may capture hand 402 and tool 404. For example, when a hardware tool is used (i.e., camera sees user's hands along with extra projections (i.e., tool 404)), the cameras and gesture recognition unit may assume that tool 404 capable of manipulating the 3D object is being used in conjunction with hand/fingers.

FIG. 48 is an example display unit 4008 showing tool 404 superimposed over a 3D object 408 as seen by the user, in the example shown in FIG. 4B, tool 404 is superimposed over a steel pipe 406 as viewed by the user in the display unit 4008. When tool 404 is moved back and forth, virtual steel pipe 408 may suffer abrasions (e.g., 408) and loses virtual content along the contour of movement of tool 404. When hand/finger/tools (e.g., 402 and 404) go away from cameras' purview, edited 3D object 408 may be saved with the changes/modifications.

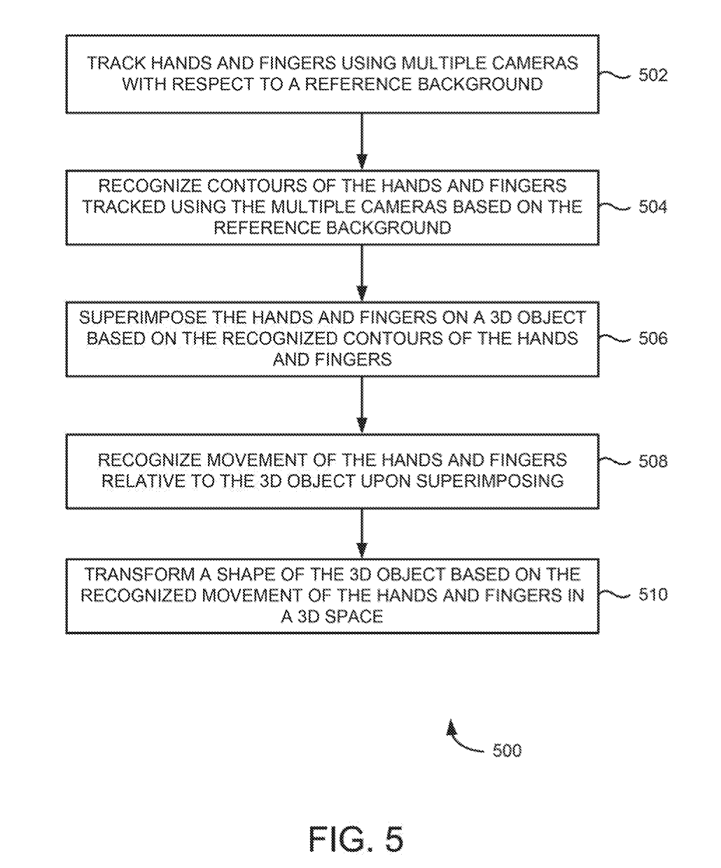

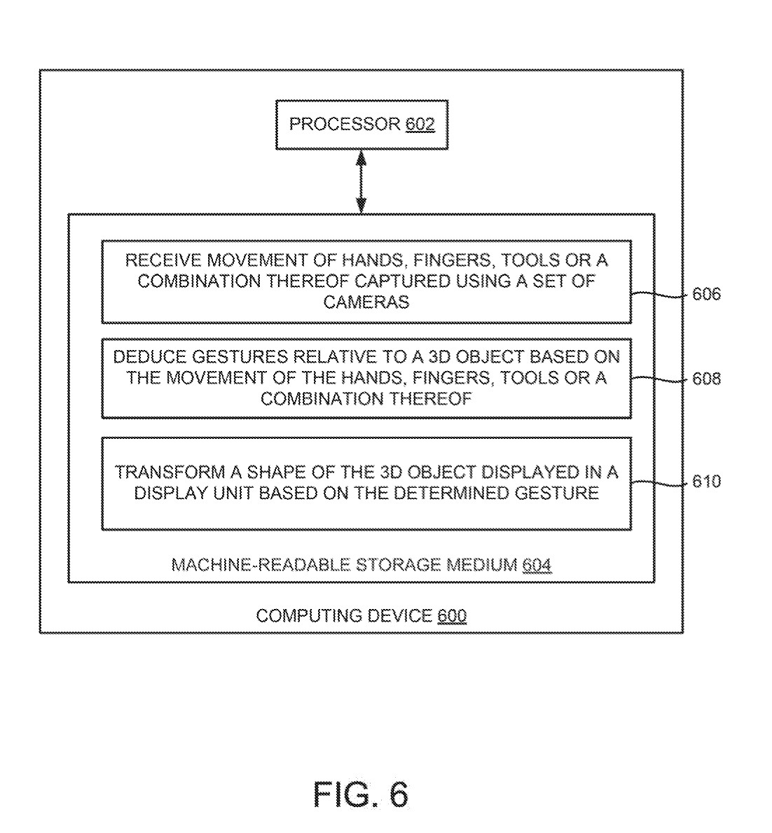

FIG. 5 is an example flow chart 500 of a method to transform a shape of a 3D object based on user's gesture. It should be understood that the process depicted in FIG. 5 represents generalized Illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, hands and fingers may be tracked using multiple cameras with respect to a reference background. At 504, contours of the hands and fingers tracked using the multiple cameras may be recognized based on the reference background. At 508, the hands and fingers may be superimposed over a 3D object based on the recognized contours of the hands and fingers. Superimposing of the user's hands and the 3D object can be viewed on a display unit. Example 3D object may include 3D stereoscopic object or 3D holographic object. Example display unit may be a 3D display device or a holographic display device.

At 508, movement of the hands and fingers relative to the 3D object may be recognized upon superimposing, in one example, when the 3D object is a 3D stereoscopic object, then the movement of hands, fingers, tools or a combination thereof may be superimposed on 3D stereoscopic object and can be displayed in the display unit. Further, movement of the hands, fingers, tools or a combination thereof may be recognized relative to the 3D stereoscopic object upon superimposing.

When the 3D object is a 3D holographic object, if is determined when the bands, fingers, tools or a combination thereof come within a predetermined range of interaction with the 3D holographic object, and movement of the hands, fingers, tools or a combination thereof may be determined relative to the 3D holographic object when the hands, fingers, tools or a combination thereof come within the predetermined range of interaction with the 3D holographic object.

At 510, a shape of the 3D object may be transformed based on the recognized movement of the hands and fingers in a 3D space. In one example, it is determined when the hands, fingers, tools or a combination thereof comes within a range of interaction with the 3D object, and when the hands, fingers, tools or a combination thereof comes within the range of interaction with the 3D object, dynamically transform the shape of the 3D object in the 3D display device based on the deduced gestures.

In another example, the flexible grid is superimposed over the 3D object to visualize a deformation to a surface of the 3D object during the transformation. For example, regular square grids on a block may mean no deformity, and if some or all the grids are not-square, the extent of deviation from square grids may represent the level of deformity of the virtual object's surface.

The process 500 of FIG. 5 may show example process and it should be understood that other configurations can be employed to practice the techniques of the present application. For example, process 500 may communicate with a plurality of computing devices and the like.

FIG. 8 illustrates a block diagram of an example computing device 600 to transform a shape of a 3D object based on user's gesture. Computing device 600 may include processor 602 and a machine-readable storage medium/memory 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing device 600.

Machine-readable storage medium 604 may store instructions 608-610. In an example, instructions 606-610 may be executed by processor 802 to transform a shape of a 3D object based on user's gesture. Instructions 606 may be executed by processor 602 to receive movement of hands, fingers, tools or a combination thereof captured using a set of cameras. Instructions 608 may be executed by processor 602 to deduce gestures relative to a 3D object based on the movement of the hands, fingers, tools or a combination thereof. Instructions 610 may be executed by processor 602 to transform a shape of the 3D object displayed in a display unit based on the determined gesture.

Examples described herein may enable to design 3D object without a need to learn complex CAD software and programming knowledge. Examples described herein may not need to know how 3D objects are represented. Examples described herein may provide ability to use different types of virtual base materials (e.g., similar to real life materials) for modelling. Examples described herein may provide texturing on the material for better visualization. Also, examples described herein may define mechanisms to provide tactile feedback using “active” gloves, thereby achieving an experience akin to modelling the object with hands using real materials.

It may be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed In this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can he based on the stimulus or a combination of stimuli including the stimulus.

The present description has been shown and described with reference to the foregoing examples. It is understood, however, that other forms, details, and examples can be made without departing from the spirit and scope of the present subject matter that is defined in the Mowing claims.

We claim:

1. An apparatus, comprising:
a display unit to display a 3D object;
a set of sensors to track movement of user's hands;
a gesture recognition unit to determine user's gesture based on tracked movement of the user's hands; and
a gesture controller to transform a shape of the 3D object based on the user's gesture, wherein the display unit is to display the transformed 3D object.

2. The apparatus of claim 1, wherein the 3D object comprises a 3D stereoscopic object, wherein the gesture recognition unit is to:
superimpose the user's hands and the 3D stereoscopic object in a virtual space, wherein superimposing of the user's hands and the 3D object is viewed on the display unit; and
determine user's gesture relative to the 3D stereoscopic object based on tracked movement of the user's hands upon superimposing the user's hands and the 3D stereoscopic object;

3. The apparatus of claim 1, wherein the 3D object comprises a 3D holographic object wherein the gesture recognition unit is to:
determine when the user's hands come within a predetermined range of interaction with the 3D holographic object; and
determine user's gesture relative to the 3D holographic object when the user's bands come within the predetermined range of interaction with the 3D holographic object.

4. The apparatus of claim 1, wherein the user's gesture comprises pushing, prodding, poking, squishing, twisting or a combination thereof.

5. The apparatus of claim 1, wherein the gesture controller is to:
enable shaping of the 3D object using physical tools, virtual tools, of a combination thereof.

6. The apparatus of claim 5, further comprising;
a recording unit to record an iteration of the movement of the user's hands, physical tools, virtual tools, or a combination thereof during the transformation of the 3D object; and
a playback unit to repeat the iteration multiple times to transform the shape of the 3D object based on user-defined rules.

7. The apparatus of claim 1, wherein the 3D object is made of a virtual material selected from a group consisting of cotton for soft and shrinkable material, wood for hard material, latex for flexible material, clay for malleable material or a combination thereof.

8. The apparatus of claim 1, further comprising:
at least one glove to provide a tactile feedback specific to a base material of the 3D object, wherein the at least one glove is to enable the gesture recognition unit to identify boundaries of the 3D object and the user's hands, and wherein the user's hands comprise right hand, left hand and/or fingers.

9. A method comprising:
tracking bands and fingers using multiple cameras with respect to a reference background;
recognizing contours of the hands and fingers tracked using the multiple cameras based on the reference background;
superimposing the hands and fingers on a 3D object based on the recognized contours of the hands and fingers;
recognizing movement of the hands and fingers relative to the 3D object upon superimposing; and
transforming a shape of the 3D object based on the recognized movement of the hands and fingers in a 3D space.

10. The method of claim 9, further comprising superimposing a flexible gild on the 3D object to visualize a deformation to a surface of the 3D object during the transformation.

11. The method of claim 9, wherein superimposing of the user's hands and the 3D object is viewed on a display unit, wherein the 3D object is 3D stereoscopic object or 3D holographic object, and wherein the display unit is a 3D display unit or a holographic display unit.

12. A non-transitory machine-readable storage medium comprising instructions executable by a processor to:
receive movement of hands, fingers, tools or a combination thereof captured using a set of cameras;
deduce gestures relative to a 3D object based on the movement of the hands, fingers, tools or a combination thereof; and
transform a shape of the 3D object displayed in a display unit based on the determined gesture.

13. The non-transitory machine-readable storage medium of claim 12, wherein the 3D object comprises a 3D stereoscopic object, wherein the instructions to:
superimpose the movement of hands, fingers, tools or a combination thereof on 3D stereoscopic object in the display unit; and
recognize movement of the hands, fingers, tools or a combination thereof relative to the 3D stereoscopic object upon superimposing.

14. The non-transitory machine-readable storage medium of claim 12, wherein the 3D object comprises a 3D holographic object, wherein the instructions to;
determine when the hands, fingers, tools or a combination thereof come within a predetermined range of interaction with the 3D holographic object; and
recognize movement of the hands, fingers, tools or a combination thereof relative to the 3D holographic object when the hands, fingers, tools or a combination thereof come within the predetermined range of interaction with the 3D holographic object.

15. The non-transitory machine-readable storage medium of claim 12, wherein the instructions to:
determine when the hands, fingers, tools or a combination thereof comes within a range of interaction with the 3D object; and
when the hands, fingers, tools or a combination thereof comes within the range of interaction with the 3D object, dynamically transform the shape of the 3D object in the display unit based on the deduced gesture.
